(19) United States
(12) Patent Application Publication
(10) Pub. No.: US 2024/0359466 A1
(43) Pub. Date: Oct. 31, 2024

(54) MAINTENANCE UNIT, LIQUID DISCHARGE APPARATUS, AND CONTROL METHOD FOR LIQUID DISCHARGE APPARATUS

(71) Applicant: SEIKO EPSON CORPORATION, Tokyo (JP)

(72) Inventor: Hisashi SATO, SHIOJIRI-SHI (JP)

(21) Appl. No.: 18/638,872

(22) Filed: Apr. 18, 2024

(30) Foreign Application Priority Data
Apr. 21, 2023 (JP) 2023-069928
Apr. 21, 2023 (JP) 2023-069929

(51) Int. Cl. B41J 2/165

(52) U.S. Cl. CPC B41J 2/16514; B41J 2002/16594; B41P 2235/242; B41P 2235/244; B41P 2235/27

(57) ABSTRACT

A maintenance unit is provided to be mounted on a liquid discharge apparatus including a discharge portion that performs printing by discharging a liquid from a nozzle to a medium when the printing is not performed, and includes a cap configured to form a space in which the nozzle is open, and a pump configured to depressurize the space.

The present application is based on, and claims priority from JP Application Serial Number 2023-069928, filed Apr. 21, 2023 and JP Application Serial Number 2023-069929, filed Apr. 21, 2023, the disclosures of which are hereby incorporated by reference herein in their entirety.

### BACKGROUND

### 1. Technical Field

The present disclosure relates to a maintenance unit, a liquid discharge apparatus, and a control method of the liquid discharge apparatus.

### 2. Related Art

JP-A-2021-59088 discloses a liquid ejecting apparatus including a liquid ejecting portion that is configured to eject a liquid from a nozzle, a suction device that performs maintenance of the liquid ejecting portion, and a housing that is provided with the liquid ejecting portion and the suction device. The suction device includes a suction cap and a decompression mechanism that depressurizes inside the suction cap. The suction cap is an example of a cap. Further, it is disclosed that the liquid ejecting apparatus performs suction cleaning of ejecting the liquid from the nozzle by depressurizing a space in which a nozzle formed in the cap is open by bringing the suction cap into contact with a liquid ejecting portion. Further, it is disclosed that the liquid ejecting apparatus performs pressurization cleaning of ejecting the pressurized liquid from the nozzle as a maintenance operation of the liquid ejecting portion.

However, in the liquid ejecting apparatus disclosed in JP-A-2021-59088, since a suction device capable of depressurizing a space formed in the suction cap is stationary provided in a housing, there is a concern that the liquid ejecting apparatus becomes large.

### SUMMARY

A maintenance unit configured to be mounted on a liquid discharge apparatus including a discharge portion that performs printing by discharging a liquid from a nozzle to a medium when the printing is not performed, the maintenance unit includes: a space forming portion configured to form a space in which the nozzle is open; and a depressurizing portion configured to depressurize the space.

A liquid discharge apparatus includes: the discharge portion; and a mounting portion on which the maintenance unit is detachably mounted.

A control method of a liquid discharge apparatus including a discharge portion that performs printing by discharging a liquid from a nozzle with respect to a medium, a maintenance unit having a space forming portion configured to form a space in which the nozzle is open, and a depressurizing portion configured to depressurize the space, and a mounting portion configured to mount the maintenance unit when the printing is not performed, the method includes: performing a notification to mount the maintenance unit on the mounting portion; performing a notification for prompting depressurization by the depressurizing portion; and performing a notification to remove the maintenance unit from the mounting portion.

### BRIEF DESCRIPTION OF THE DRAWINGS

FIG. 1 is a schematic front view illustrating a liquid discharge apparatus according to Embodiment 1.

FIG. 2 is a schematic top view illustrating the liquid discharge apparatus in which a support portion is at a placement position.

FIG. 3 is a schematic side view illustrating a wiping unit.

FIG. 4 is a perspective view of a maintenance unit.

FIG. 5 is a perspective view of the maintenance unit.

FIG. 6 is a top view of the maintenance unit.

FIG. 7 is a top view illustrating the liquid discharge apparatus in which the maintenance unit is mounted on the support portion at the placement position.

FIG. 8 is a schematic top view illustrating the liquid discharge apparatus.

FIG. 9 is a schematic sectional view illustrating the liquid discharge apparatus.

FIG. 10 is a schematic sectional view illustrating the liquid discharge apparatus.

FIG. 11 is a schematic sectional view illustrating the liquid discharge apparatus.

FIG. 12 is a schematic sectional view illustrating the liquid discharge apparatus.

FIG. 13 is a flowchart illustrating an example of liquid filling processing.

FIG. 14 is a schematic sectional view illustrating a liquid discharge apparatus according to Embodiment 2.

FIG. 15 is a schematic sectional view illustrating a liquid discharge apparatus according to Embodiment 3.

### DESCRIPTION OF EMBODIMENTS

Hereinafter, the present disclosure will be described based on embodiments. In each drawing, the same members will be given the same reference numerals, and redundant descriptions thereof will be omitted. In the present specification, “same”, “equal”, and “simultaneous” not only mean completely the same state, but also mean a case of being in the same in consideration of a measurement error, a case of being the same in consideration of manufacturing variation of members, and a case of being the same as long as the functions are not impaired. Therefore, for example, “the dimensions of both are the same” means that the dimensional difference between the two is within ±10%, more preferably within ±5%, and particularly preferably within ±3% of one of the dimensions, in consideration of the measurement error and the manufacturing variation of members.

In each of the drawings, X, Y, and Z represent three spatial axes orthogonal to each other. In the present specification, the directions along these axes are referred to as an X-axis direction, a Y-axis direction, and a Z-axis direction. When specifying the direction, the positive direction is “+”, the negative direction is “−”, and by using the positive and negative signs together in the direction notation, the direction in which the arrow points in each drawing will be described as the + direction, and the direction opposite to the arrow will be described as the − direction.

Further, the Z-axis direction indicates a gravity direction, the +Z direction indicates a vertically upward direction, and the −Z direction indicates a vertically downward direction. Further, a plane including the X-axis and the Y-axis will be described as an X-Y plane, a plane including the X-axis and the Z-axis will be described as an X-Z plane, and a plane including the Y-axis and the Z-axis will be described as a Y-Z plane. Further, the X-Y plane is a horizontal plane. Furthermore, the three spatial axes X, Y, and Z, which do not limit the positive direction and the negative direction, will be described as an X-axis, a Y-axis, and a Z-axis.

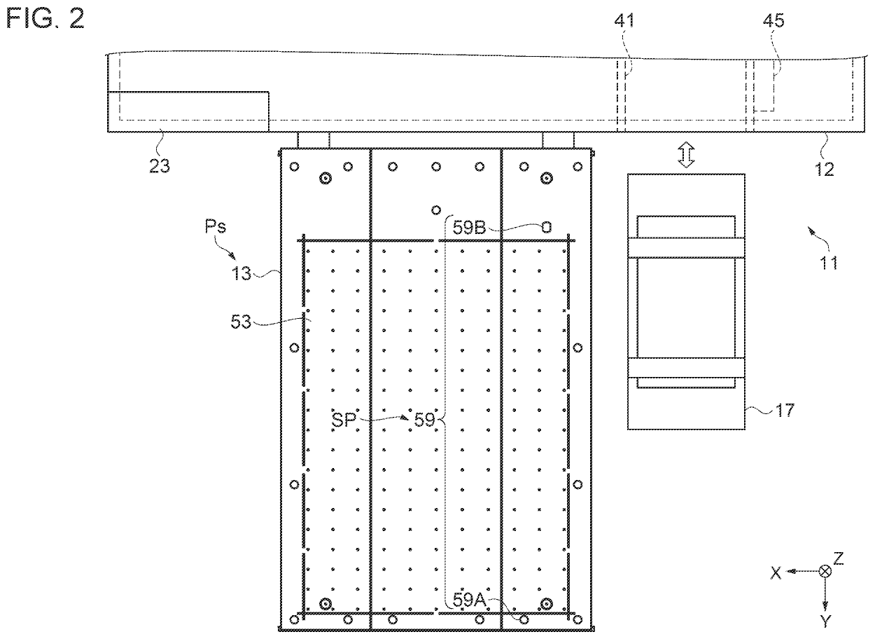

Furthermore, in each drawing, an X-axis direction is a width direction of a housing 12 in a liquid discharge apparatus 11, which will be described later, and is also a direction intersecting a feeding direction in which the absorbing member 25 is transported, that is, the width direction of the absorbing member 25. In the X-axis direction, the −X direction is the right direction when viewed from the operator when the front surface of the housing 12 faces the operator, and the +X direction is the left direction. In the present embodiment, among side surfaces constituting the periphery of the housing 12, a side surface (refer to FIG. 2) on which the wiping unit 17 is attached and detached is a front surface of the housing 12.

The Y-axis direction is a depth direction of the housing 12. In the Y-axis directions, the −Y direction is a direction from the front surface of the housing 12 toward the back surface of the housing 12. In the Y-axis directions, the +Y-direction is a direction from the back surface of the housing 12 toward the front surface of the housing 12.

### 1. Embodiment 1

The liquid discharge apparatus 11 is an ink jet type printer that prints images such as characters and photographs by discharging ink, which is an example of a liquid, onto a medium M such as paper or cloth.

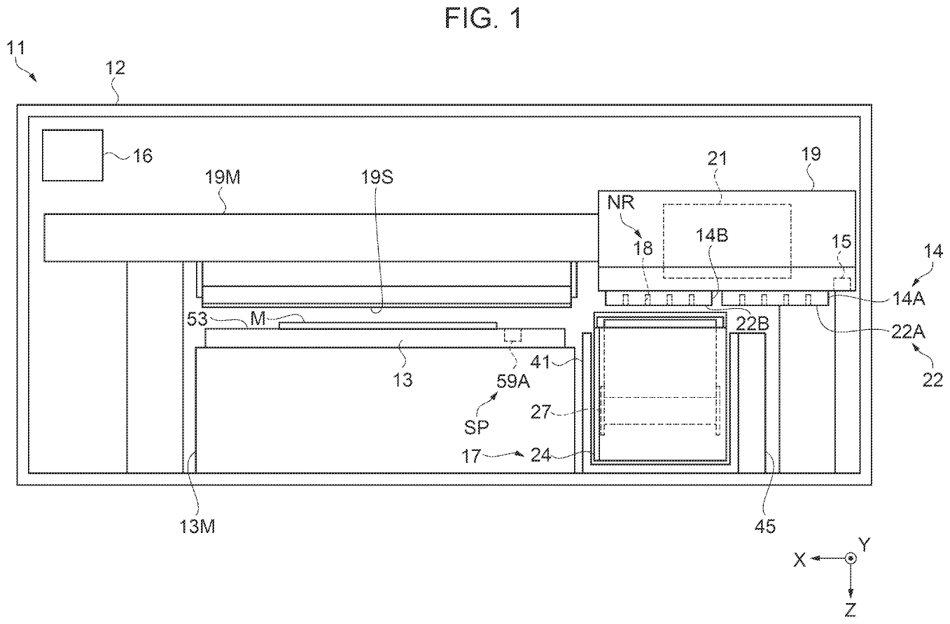

As illustrated in FIGS. 1 and 2, the liquid discharge apparatus 11 includes the housing 12, a support portion 13, a discharge portion 14, a carriage 19, a processing portion 15, a control portion 16, and a wiping unit 17. Further, the liquid discharge apparatus 11 includes a support portion movement mechanism 13M, a carriage movement mechanism 19M, and a notification portion 23 (refer to FIG. 2). The housing 12 accommodates various configurations of the liquid discharge apparatus 11.

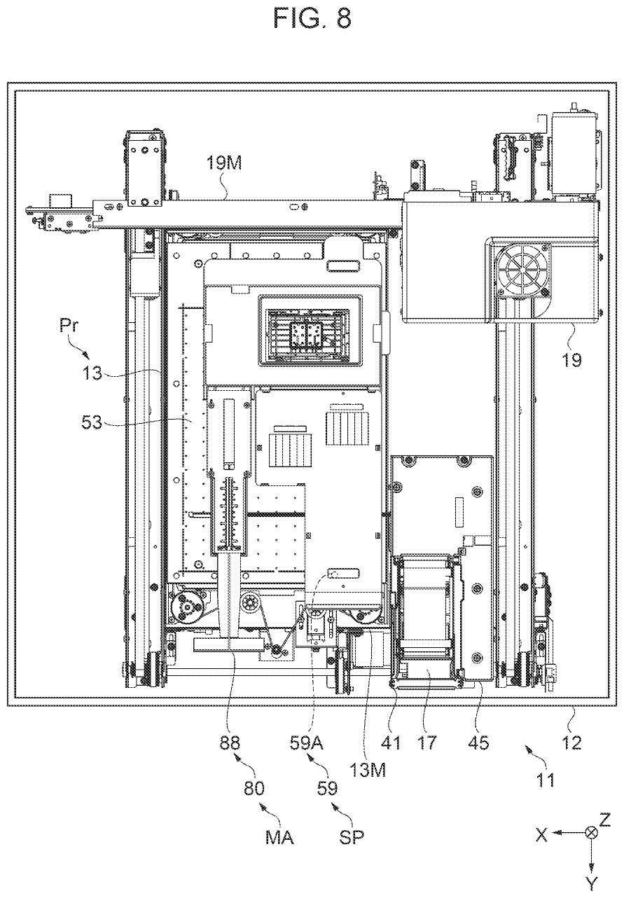

The support portion 13 is configured to support the medium M. The support portion 13 supports the medium M. The support portion 13 has a support surface 53 that supports the medium M. The support portion 13 is supported by the support portion movement mechanism 13M provided in the housing 12 to be movable in the Y-axis direction and the Z-axis direction. The support portion 13 is movably provided along the Y-axis direction between a placement position Ps (refer to FIG. 2) on the +Y direction side of the housing 12 and a printing position Pr (refer to FIG. 8) positioned in the housing 12. The placement position Ps is a position where the medium M is placed. The printing position Pr is a position where the discharge portion 14 performs printing on the medium M supported by the support portion 13.

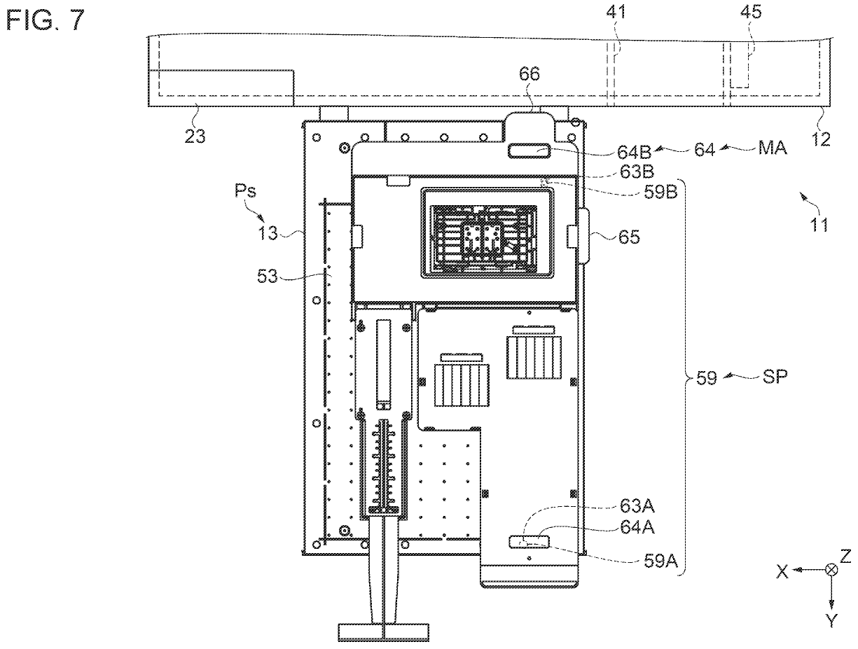

The liquid discharge apparatus 11 includes a mounting portion SP in which a maintenance unit MA, which will be described later, can be mounted on the support portion 13. The mounting portion SP has a positioning portion 59 for positioning the maintenance unit MA. As illustrated in FIG. 2, the positioning portion 59 includes a positioning hole 59A and a positioning hole 59B. The positioning hole 59A is a square-shaped hole that opens to the support surface 53. The positioning hole 59B is an oval hole open to the support surface 53. Furthermore, the maintenance unit MA is attached to and detached from the mounting portion SP at the placement position Ps, as illustrated in FIG. 7.

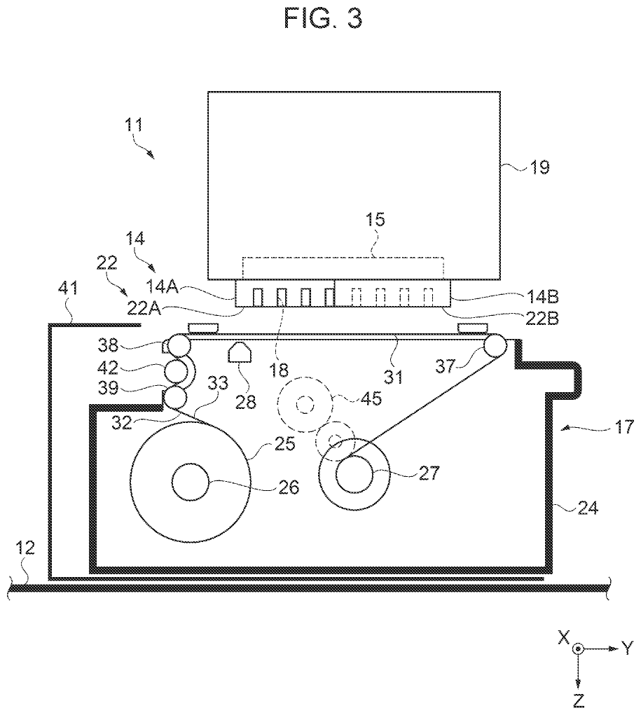

As illustrated in FIG. 1, the discharge portion 14 is configured to discharge a liquid. The discharge portion 14 has nozzles 18 that discharge the liquid, that is, one or more nozzles 18 that open on a nozzle surface 22 that is a surface of the discharge portion 14 on the +Z direction side. The discharge portion 14 includes a discharge portion 14A and a discharge portion 14B. The discharge portion 14B is disposed at a position separated from the discharge portion 14A in the +X direction and the +Y direction (refer to FIG. 3). The discharge portions 14A and 14B have nozzles 18 that open on the respective nozzle surfaces 22A and 22B, which are surfaces on the +Z direction side. At the printing position Pr, the discharge portion 14 discharges the liquid from the nozzle 18 onto the medium M supported by the support portion 13 to print an image on the medium M.

The discharge portion 14 may have a plurality of nozzle groups NR including a plurality of nozzles 18 in the discharge portions 14A and 14B. The discharge portion 14 may be configured to discharge different types of liquids from the respective nozzle groups NR. The plurality of nozzle groups NR may be disposed at intervals in the X-axis direction. In addition, the plurality of nozzles 18 constituting the nozzle group NR may be arranged at intervals in the Y-axis direction to form a nozzle row.

The discharge portion 14 is mounted on the carriage 19. The carriage 19 scans the medium M in the X-axis direction, and thus the discharge portion 14 prints an image on the medium M. In the present embodiment, the carriage 19 is supported by the carriage movement mechanism 19M provided in the housing 12 to be movable in the X-axis direction and the Y-axis direction. That is, the liquid discharge apparatus 11 is a so-called lateral printer. Furthermore, the liquid discharge apparatus 11 may be a serial printer that scans against the medium M, or may be a line printer that can discharge the liquid all at once across the width of the medium M.

Furthermore, the carriage movement mechanism 19M is provided with a medium detection sensor 19S. For example, when the position of the medium M placed on the support portion 13 in the Z-axis direction is closer to the discharge portion 14 than the assumed position, there is a concern that the medium M comes into contact with the discharge portion 14. The medium detection sensor 19S detects the medium M when the position of the medium M placed in the support portion 13 in the Z-axis direction is closer to the discharge portion 14 than the assumed position. Thereby, the medium M placed on the support portion 13 or the maintenance unit MA, which will be described later, can be prevented from coming into contact with the discharge portion 14.

In addition, a liquid accommodation portion 21 is detachably mounted on the carriage 19. The liquid accommodation portion 21 is configured to accommodate the liquid. The liquid accommodation portion 21 is coupled to the discharge portion 14 by a supply flow path (not illustrated). Thereby, the liquid accommodated in the liquid accommodation portion 21 is supplied to the discharge portion 14. The liquid accommodation portion 21 may be provided in an attachable/detachable portion provided in the housing 12. For example, the attachable/detachable portion may be provided at a position between the side wall of the housing 12 on the +X direction side and the support portion 13.

The processing portion 15 is configured to cure the liquid by applying energy to the liquid. The processing portion 15 is configured to release the energy, for example, light energy, thermal energy, electrical energy, and the like. The processing portion 15 releases the energy, for example, when a voltage is applied. The curing of the liquid is promoted by the processing portion 15 applying energy corresponding to the properties of the liquid to the liquid.

In the present embodiment, the processing portion 15 is configured to irradiate the liquid with ultraviolet rays, so-called UV light, as an example of the light energy. Therefore, the processing portion 15 of the present embodiment includes, for example, a light emitting element. In the present embodiment, the liquid discharged by the discharge portion 14 is cured by irradiation with ultraviolet rays performed as processing. In the present embodiment, the liquid discharged by the discharge portion 14 is, for example, an ultraviolet curable ink, a so-called UV ink. The ultraviolet curable ink is an example of ink and an example of a liquid.

The liquid discharged by the discharge portion 14 may be a liquid containing a thermosetting resin, for example, a thermosetting ink. The thermosetting ink is an example of ink and an example of a liquid. The thermosetting ink is cured by heating performed as processing. In this case, for example, the processing portion 15 may give infrared rays to the liquid, may give radiant heat to the liquid, or may give microwaves to the liquid.

The processing portion 15 is mounted, for example, on the carriage 19. The processing portion 15 is mounted on the carriage 19 aligned to the discharge portion 14 in the X-axis direction. In the present embodiment, the processing portion 15 is disposed on the −X direction side of the discharge portion 14. The processing portion 15 may be mounted on the carriage 19 adjacent to the discharge portion 14 in the Y-axis direction. In this case, the processing portion 15 may be disposed on the +Y direction side of the discharge portion 14. The processing portion 15 fixes the liquid on the medium M by applying energy to the liquid discharged to the medium M while the carriage 19 moves.

As illustrated in FIG. 2, the notification portion 23 is provided at a position constituting the side surface on the +Y direction side that is the front surface of the housing 12. The notification portion 23 has a monitor, a touch panel, and the like, and notifies the operator and the like by displaying a message.

As illustrated in FIGS. 1 and 2, the wiping unit 17 is detachably provided with respect to the holding portion 41 from the +Y direction side, which is the front surface of the housing 12. The holding portion 41 is provided at a position adjacent to the support portion 13 on the −X direction side in the housing 12. The wiping unit 17 mounted on the holding portion 41 is positioned at a position adjacent to the support portion 13 on the −X direction side. The holding portion 41 has a drive portion 45. When the wiping unit 17 is mounted on the holding portion 41, the drive portion 45 drives a rotating body 27 of the wiping unit 17, which will be described later.

The wiping unit 17 is configured to receive the liquid ejected from the discharge portion 14 as a waste liquid. The waste liquid is a liquid that does not contribute to the image printed on the medium M. The waste liquid is generated, for example, by maintenance of the discharge portion 14. When printing is being performed by the discharge portion 14, the wiping unit 17 receives the waste liquid ejected from the discharge portions 14A and 14B positioned immediately above the wiping unit 17 by the absorbing member 25, which will be described later. Examples of the maintenance of the discharge portion 14 in which the wiping unit 17 collects the waste liquid include flushing, pressurization cleaning, and wiping. In the present embodiment, the maintenance of the discharge portion 14 by the wiping unit 17 is performed for each of the discharge portions 14A and 14B positioned immediately above the wiping unit 17.

Flushing is an operation of appropriately discharging a liquid from the nozzle 18 in order to suppress clogging of the nozzle 18. Flushing is executed, for example, before printing, during printing, and after printing. When the flushing is executed, the discharge portion 14 discharges the liquid toward either the wiping unit 17 or the maintenance unit MA, which will be described later.

The pressurization cleaning is an operation of forcibly ejecting the liquid in the supply flow path and the discharge portion 14 from the nozzle 18 by pressurizing the supply flow path or the liquid accommodation portion 21 upstream in the supply direction of the liquid supplied to the discharge portion 14. The pressurization cleaning is performed for the purpose of ejecting air bubbles in the discharge portion 14 and in the supply flow path supplying the liquid to the discharge portion 14, suppressing the thickening of the liquid, and the like.

Wiping is an operation of wiping the discharge portion 14 to remove the liquid adhering to the nozzle surface 22 of the discharge portion 14. Wiping is executed, for example, after the pressurization cleaning. In the present embodiment, when the wiping is executed, the discharge portion 14 performs wiping by either the wiping unit 17 or the maintenance unit MA.

As illustrated in FIG. 3, the wiping unit 17 has a case 24, an absorbing member 25 capable of absorbing a liquid, and rotating bodies 26 and 27 that hold the absorbing member 25. Further, the wiping unit 17 includes a pressing portion 28 that presses the absorbing member 25 against the discharge portion 14, guide rollers 37, 38, and 39 that guide the absorbing member 25, and a tension roller 42.

The case 24 accommodates, for example, the absorbing member 25, the rotating bodies 26 and 27, the pressing portion 28, the guide rollers 37, 38, and 39, the tension roller 42, and the like. The case 24 has an opening that exposes a first surface 32 of the absorbing member 25, which will be described later, on the upper surface that is a side surface on the −Z direction side.

The absorbing member 25 absorbs the liquid from the discharge portion 14. The absorbing member 25 absorbs the waste liquid. The absorbing member 25 may be, for example, a cloth or a sponge. The absorbing member 25 is a band-shaped elongated member capable of absorbing the liquid. The width of the absorbing member 25 is the same as or larger than the dimension of the nozzle surfaces 22A and 22B of the discharge portions 14A and 14B in the X-axis direction.

The absorbing member 25 is held by the rotating bodies 26 and 27. The absorbing member 25 has an intermediate part. The intermediate part is a part of the absorbing member 25 that is between a part held by the rotating body 26 and a part held by the rotating body 27. The intermediate part is a part between a part wound around the rotating body 26 and a part wound around the rotating body 27. The absorbing member 25 receives the liquid by the flushing, the pressurization cleaning, and the wiping at a facing part 31 facing the discharge portion 14 at the intermediate part.

As illustrated in FIG. 3, the absorbing member 25 has the first surface 32 and a second surface 33. The first surface 32 is a surface that receives the liquid from the discharge portion 14. Therefore, the first surface 32 is a surface facing the discharge portion 14 at the facing part 31. The second surface 33 is a surface opposite to the first surface 32.

The rotating body 26 holds an unused absorbing member 25. That is, the rotating body 26 holds the absorbing member 25 that does not absorb the liquid. Therefore, the rotating body 26 also functions as a supply portion that supplies the unused absorbing member 25. The rotating body 26 is rotatably held by the case 24. The rotating body 26 is an example of a feeding shaft that feeds the absorbing member 25.

The rotating body 27 holds the used absorbing member 25. That is, the rotating body 27 holds the absorbing member 25 that absorbed the liquid. Therefore, the rotating body 27 also functions as a collection portion that collects the used absorbing member 25. The rotating body 27 is held by the case 24 to be rotatable. The rotating body 27 is an example of a winding shaft that winds the absorbing member 25.

The rotating body 27 holds an absorbing member 25 wound in a roll shape. In the present embodiment, the rotating body 27 holds the absorbing member 25 such that the first surface 32 is inside. That is, the rotating body 27 holds the absorbing member 25 such that the second surface 33 is an outside.

The rotating body 26 and the rotating body 27 are disposed to be aligned in the Y-axis direction. The rotating bodies 26 and 27 are disposed such that a central axis, which is an axis on which the rotating bodies 26 and 27 rotate, extends in the X-axis direction in which the carriage 19 scans.

When the wiping unit 17 is mounted on the holding portion 41, the rotating bodies 26 and 27 can be driven by the drive portion 45. The rotating bodies 26 and 27 rotate by being driven by the drive portion 45. The rotating bodies 26 and 27 feed or wind the absorbing member 25 by rotating. Hereinafter, a direction in which the absorbing member 25 is fed from the rotating body 26 toward the rotating body 27 by winding the absorbing member 25 around the rotating body 27 is referred to as a feeding direction. That is, the absorbing member 25 is fed toward the downstream or the upstream in the feeding direction by the rotation of the rotating bodies 26 and 27.

The guide roller 37 is provided at a position on the side of the −Z direction from the rotating bodies 26 and 27 in the Z-axis direction. The guide roller 37 is provided at a position on the +Y direction side of the center of the opening of the case 24 in the Y-axis direction. The guide roller 37 is disposed such that a central axis extends in the X-axis direction. The guide roller 37 is rotatably held by the case 24.

The guide roller 38 is provided at the same position as the guide roller 37 in the Z-axis direction. The guide roller 38 is provided at a position on the −Y direction side of the center of the opening of the case 24 in the Y-axis direction. The guide roller 38 is provided at an interval from the guide roller 37 in the Y-axis direction. The guide roller 38 is disposed such that a central axis extends in the X-axis direction. The guide roller 38 is rotatably held by the case 24.

The absorbing member 25 is wound around the guide rollers 37 and 38. The absorbing member 25 is wound at an acute angle with respect to the guide roller 37. Further, the absorbing member 25 is wound at an acute angle with respect to the guide roller 38. An intermediate part of the absorbing member 25 is wound around the guide rollers 37 and 38. The facing part 31 is formed by the intermediate part wound around the guide rollers 37 and 38. The facing part 31 is along the X-Y plane when not pressed by the pressing portion 28, which will be described later.

As illustrated in FIG. 3, the guide roller 39 is provided at a position between the rotating body 26 and the guide roller 38 in the Z-axis direction. The intermediate part wound between the guide roller 38 and the guide roller 39 is pressed in the +Y direction by the tension roller 42. As a result, tension is applied to the intermediate part of the absorbing member 25. The tension roller 42 is disposed such that a central axis extends in the X-axis direction. The tension roller 42 is rotatably held by the case 24.

The guide rollers 37, 38, and 39 guide the absorbing member 25 unwound from the rotating body 26 toward the rotating body 27. The absorbing member 25 is fed from the rotating body 26 to the rotating body 27 via the guide roller 39, the tension roller 42, the guide roller 38, and the guide roller 37 in order from the upstream in the feeding direction.

The pressing portion 28 is provided at a position between the guide roller 37 and the guide roller 38 in the feeding direction. The pressing portion 28 is positioned between the guide roller 37 and the guide roller 38 in the Y-axis direction. The pressing portion 28 is positioned near the guide roller 38 of the guide rollers 37 and 38 in the Y-axis direction.

The pressing portion 28 is provided to extend in the X-axis direction. The pressing portion 28 has, for example, a projection portion protruding in the −Z direction when viewed from a direction along the X-axis direction. The pressing portion 28 is held by the case 24 such that the projection portion extends in the X-axis direction along the facing part 31.

The pressing portion 28 comes into contact with the second surface 33. By moving, the pressing portion 28 presses a wiping region of the facing part 31 positioned vertically above the pressing portion 28 on the −Z direction side against the nozzle surface 22 of the discharge portion 14. The pressing portion 28 is configured to move in the Z-axis direction between a pressing position and a non-contact position. The pressing position is a position where the pressing portion 28 presses the wiping region of the facing part 31 against the nozzle surface 22 of the discharge portion 14 in a state of being contact with the second surface 33. The non-contact position is a position on the +Z direction side of the pressing position, and is a position where the pressing portion 28 does not come into contact with the second surface 33.

In a state where the pressing portion 28 presses the facing part 31 against the nozzle surface 22 of the discharge portion 14, wiping is executed by relatively moving the discharge portion 14 and the wiping unit 17. In wiping, the wiping region of the facing part 31 pressed against the nozzle surface 22 of the discharge portion 14 is positioned on the guide roller 38 side from the center of the facing part 31 in the Y-axis direction. Further, the wiping region is positioned upstream of the receiving region of the facing part 31 in the feeding direction that receives the liquid by the flushing and the pressurization cleaning. As a result, wiping can be executed by the unused absorbing member 25.

In the wiping of the present embodiment, the discharge portion 14 moves with respect to the wiping unit 17. However, the wiping unit 17 may move with respect to the discharge portion 14 and both the discharge portion 14 and the wiping unit 17 may move. In the present embodiment, when the wiping is executed, the discharge portion 14 moves in the −Y direction with respect to the wiping unit 17 in a state where the absorbing member 25 is pressed against the end of the discharge portion 14 on the −Y direction side. As a result, the nozzle surface 22 on which the nozzle 18 of the discharge portion 14 is open is wiped off from the end on the −Y direction side to the end on the +Y direction side by the absorbing member 25.

As illustrated in FIGS. 7 and 8, the maintenance unit MA is mounted on the mounting portion SP of the support portion 13, and accordingly, the liquid from the discharge portion 14 can be collected as the waste liquid. Therefore, the maintenance unit MA can collect the liquid from the discharge portion 14 as the waste liquid when the medium M is not placed on the support portion 13. When printing by the discharge portion 14 is performed on the medium M placed on the support portion 13, the maintenance unit MA is removed from the mounting portion SP. In other words, the maintenance unit MA is mounted on the mounting portion SP when the printing is not performed by the discharge portion 14.

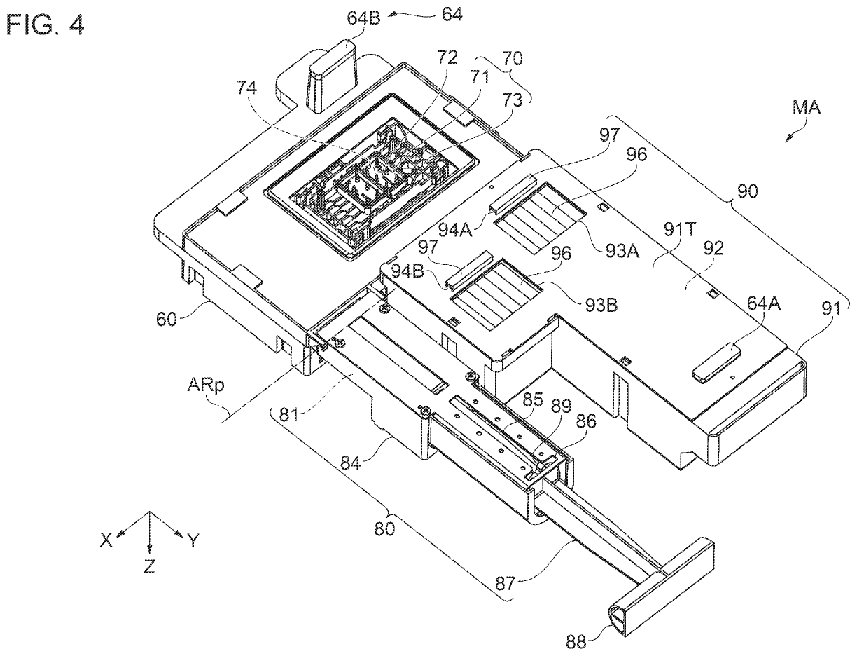

As illustrated in FIGS. 4 to 6, the maintenance unit MA includes a base portion 60, a cap portion 70, a pump portion 80, and a receiving portion 90. The maintenance unit MA of the present embodiment can execute suction cleaning by the cap portion 70 and the pump portion 80. Therefore, the maintenance unit MA can be applied to the maintenance processing for the purpose of ejecting the air bubbles retained in the discharge portion 14. Further, the amount of liquid that can be received by the receiving portion 90 included in the maintenance unit MA of the present embodiment is set to be larger than the amount of liquid that can be received by the wiping unit 17. Therefore, the maintenance unit MA is applicable to the maintenance processing of the discharge portion 14 in which the amount of liquid ejected from the discharge portion 14 is relatively large.

The maintenance unit MA can be used for the general maintenance of the discharge portion 14, but, from the above-mentioned characteristics, the maintenance unit MA is mainly used for the liquid filling processing of filling the supply flow path for supplying the liquid to the discharge portion 14 and the discharge portion 14 with the liquid. The liquid filling processing of filling the discharge portion 14 and the supply flow path with the liquid by the maintenance unit MA is an example of maintenance of the discharge portion 14. Furthermore, the liquid filling processing is executed not only when the liquid discharge apparatus 11 is operated for the first time, but also when the liquid discharge apparatus 11 in which the liquid is ejected from the discharge portion 14 and the supply flow path for long-term storage is operated.

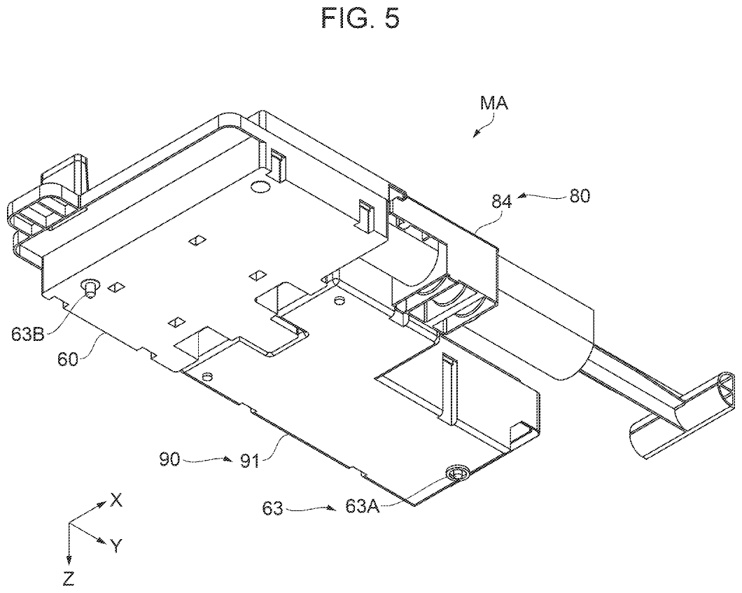

Further, the maintenance unit MA includes a position aligning portion 63 and detected portions 64, 65, and 66. As illustrated in FIG. 5, the position aligning portion 63 includes a position aligning projection 63A and a position aligning projection 63B. The position aligning projections 63A and 63B are columnar projections protruding in the +Z direction. As illustrated in FIG. 7, the position aligning projection 63A is inserted into the positioning hole 59A of the mounting portion SP, and the position aligning projection 63B is inserted into the positioning hole 59B of the mounting portion SP, and accordingly, the maintenance unit MA is positioned with respect to the mounting portion SP of the support portion 13.

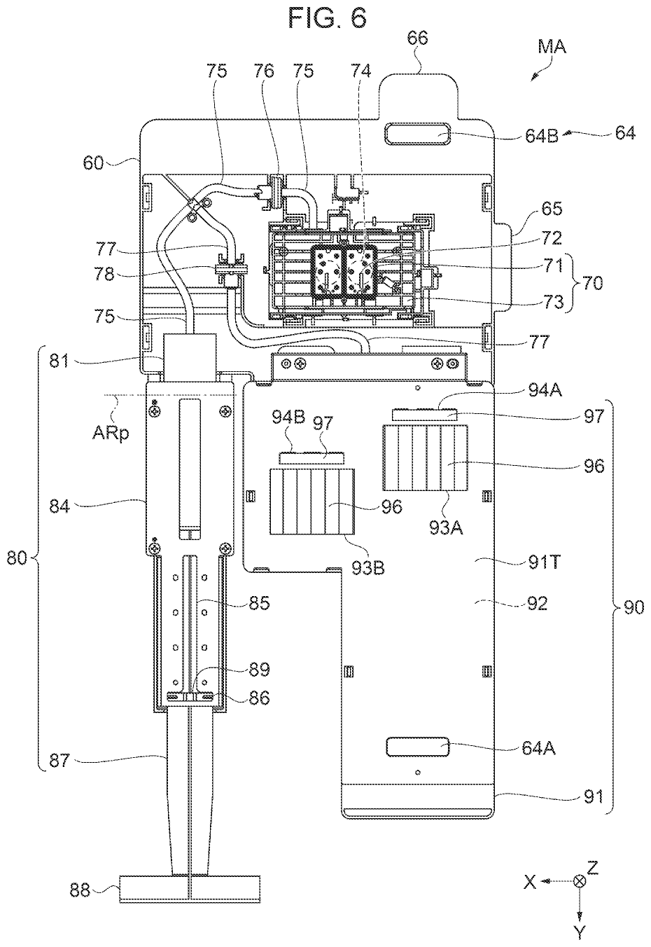

As illustrated in FIGS. 4 and 6, the detected portion 64 includes a detected portion 64A and a detected portion 64B. The detected portions 64A and 64B are projections that protrude in the −Z direction. For example, the liquid discharge apparatus 11 confirms whether or not the upper surfaces of the detected portions 64A and 64B on the −Z direction side are detected, by the medium detection sensor 19S (refer to FIG. 1) provided in the carriage movement mechanism 19M. Further, the liquid discharge apparatus 11 confirms the position of the end of the detected portion 65 on the −X direction side and the position of the end of the detected portion 66 on the −Y direction side by the sensor (not illustrated).

As a result, the liquid discharge apparatus 11 can confirm whether or not the maintenance unit MA is correctly mounted on the support portion 13. Alternatively, the liquid discharge apparatus 11 may adjust the position of the maintenance unit MA in the Z-axis direction by raising and lowering the support portion 13 in the Z-axis direction with reference to a position where the upper surfaces of the detected portions 64A and 64B are detected by the medium detection sensor 19S.

The base portion 60 holds the cap portion 70. Further, the pump portion 80 and the receiving portion 90 are attached to the base portion 60. As illustrated in FIG. 5, the position aligning projection 63B is provided on the bottom surface of the base portion 60 on the +Z direction side. Further, as illustrated in FIGS. 4 and 6, the base portion 60 is provided with the detected portion 64B at a position on the −Y direction side of the cap portion 70. Further, the base portion 60 is provided with the detected portion 65 at a position on the −X direction side of the cap portion 70. In addition, the base portion 60 is provided with the detected portion 66 at a position on the −Y direction side of the detected portion 64B.

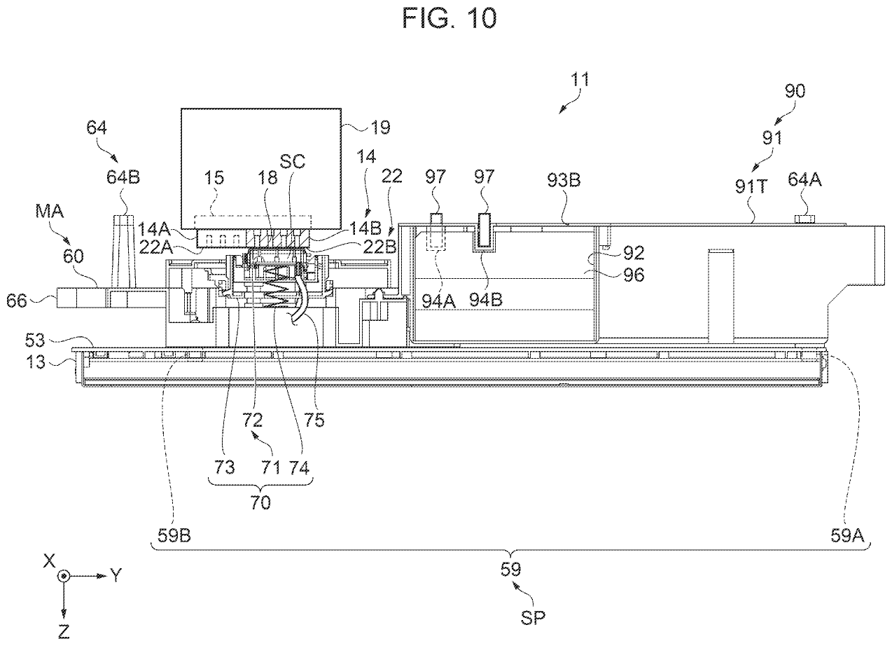

As illustrated in FIGS. 4, 6, 9, and 10, the cap portion 70 has a cap 71, a cap holder 73, and a pressing spring 74. The cap 71 is held by the cap holder 73 to be able to come into contact with the nozzle surface 22 of the discharge portion 14 on which the nozzle 18 is open. As illustrated in FIG. 10, the cap 71 has a recessed portion 72 that can form a space SC where the nozzle 18 opens by coming into contact with the nozzle surface 22. The cap 71 is an example of a space forming portion capable of forming the space SC where the nozzle 18 is open. The pressing spring 74 presses the cap 71 in a direction toward the nozzle surface 22.

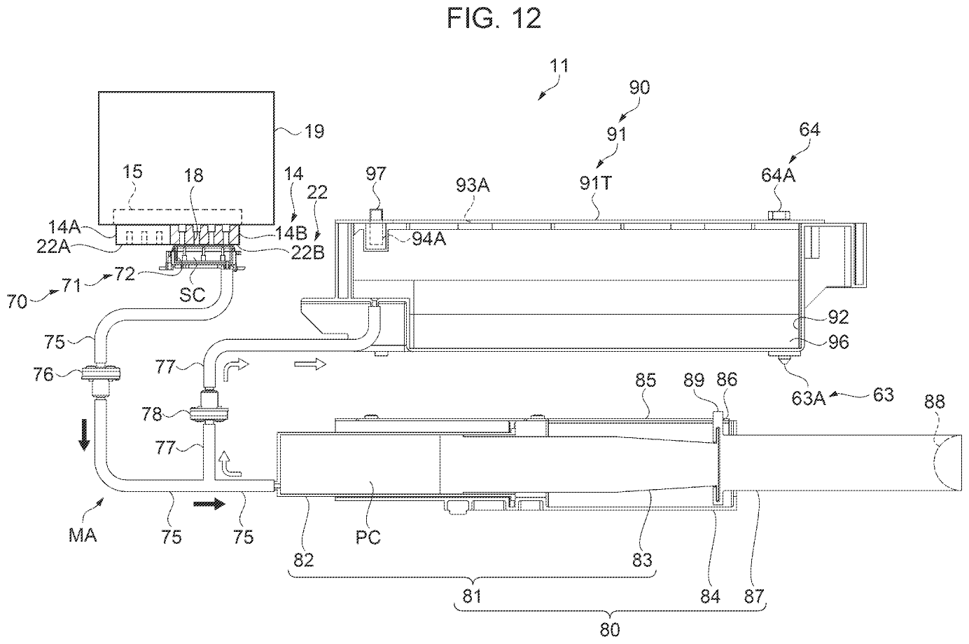

As illustrated in FIGS. 4, 6, 11, and 12, the pump portion 80 has a pump 81, a holder 84, and an operation portion 87. The pump portion 80 is positioned on the +Y direction side of the base portion 60 and the cap portion 70. As illustrated in FIG. 12, the pump 81 is coupled to the cap 71 by a first tube 75 such that the space SC can be depressurized. The pump 81 is an example of a depressurizing portion capable of depressurizing the space SC. Furthermore, the first tube 75 is provided with a one-way valve 76 that allows the flow of fluid from the cap 71 to the pump 81 and restricts the flow of fluid from the pump 81 to the cap 71.

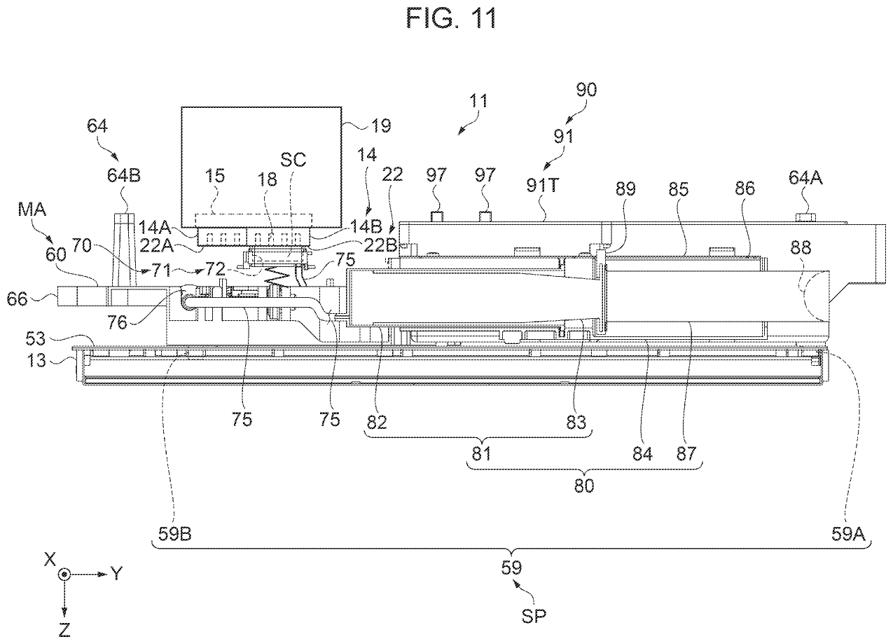

As illustrated in FIG. 11, the pump 81 is a so-called syringe pump including a cylindrical outer pipe 82 of which the central axis is in the Y-axis direction, and a columnar pusher 83 capable of sliding in the outer pipe 82 in the Y-axis direction. The pump 81 can depressurize the space SC by sliding the pusher 83 in the direction in which the volume of a pump chamber PC (refer to FIG. 12) formed between the outer pipe 82 and the pusher 83 increases. In the present embodiment, by depressurizing the space SC by the pump 81 of the pump portion 80, it is possible to perform suction cleaning that ejects the liquid in the supply flow path and the discharge portion 14 from the nozzle 18 to the space SC.

The holder 84 holds the pump 81. As illustrated in FIGS. 4 and 6, the holder 84 is rotatably attached to the base portion 60 at the center of an axis ARp along the X-axis. As a result, the pump portion 80 is rotatably attached to the base portion 60 about the center of the axis ARp along the X-axis. A guide slit 85 extending in the Y-axis direction and a guide slit 86 extending in the +X direction and the −X direction from the end of the guide slit 85 on the +Y direction side are provided on an upper surface of the holder 84, which is a surface on the −Z direction side.

As illustrated in FIGS. 11 and 12, the operation portion 87 is attached to the end of the pusher 83 of the pump 81 on the +Y direction side. The operation portion 87 has a grip portion 88 that can be gripped by the operator and a slider 89 that is guided by the guide slits 85 and 86 of the holder 84. The grip portion 88 is provided at the end of the operation portion 87 on the +Y direction side. When an operator grips the grip portion 88 and moves the grip portion 88 in the Y-axis direction, the pusher 83 of the pump 81 slides in the Y-axis direction. The volume of the pump chamber PC in the pump 81 changes by moving the pusher 83 in the Y-axis direction. In other words, the pump 81 can be manually driven by operating the operation portion 87 by an operator.

The slider 89 is provided at the end of the operation portion 87 on the −Y direction side. The slider 89 is a projection of which movement is restricted by the guide slits 85 and 86 of the holder 84. When the slider 89 is in the guide slit 85, the operation portion 87 and the pusher 83 can move in the Y-axis direction, and thus the volume of the pump chamber PC in the pump 81 is variable.

On the other hand, it is assumed that the slider 89 is positioned in the guide slit 86 by rotating the operation portion 87 around the central axis center of the outer pipe 82 of the pump 81. In this case, the movement of the operation portion 87 and the pusher 83 in the Y-axis direction is restricted. For example, in a state where the space SC is depressurized, a force for moving the pusher 83 in the −Y direction, which is a direction in which the volume of the pump chamber PC decreases, acts. In such a case, by positioning the slider 89 in the guide slit 86, it is possible to restrict the change in the volume of the pump chamber PC.

The receiving portion 90 receives the liquid ejected from the nozzle 18 of the discharge portion 14 as a waste liquid. As illustrated in FIGS. 4 to 6, the receiving portion 90 includes a housing 91, a first collection portion 96, and a second collection portion 97. The receiving portion 90 is positioned on the +Y direction side of the base portion 60 and the cap portion 70. The receiving portion 90 is positioned on the −X direction side of the pump portion 80.

As illustrated in FIGS. 4 to 6, 9, and 12, the housing 91 includes an accommodation chamber 92, attachment portions 94A and 94B, and a detected portion 64A. As illustrated in FIG. 12, the accommodation chamber 92 accommodates the first collection portion 96. The accommodation chamber 92 is coupled to one end of a second tube 77. The other end of the second tube 77 is coupled to a position on the pump portion 80 side from the one-way valve 76 in the first tube 75. As a result, the receiving portion 90 can receive the liquid as waste liquid ejected from the nozzle 18 of the discharge portion 14 in the accommodation chamber 92 via the space SC, the first tube 75, and the second tube 77.

In addition, the second tube 77 is provided with a one-way valve 78 that allows the flow of fluid from the first tube 75 side toward the accommodation chamber 92 and restricts the flow of fluid from the accommodation chamber 92 toward the first tube 75. As a result, it is possible to suppress the liquid accommodated in the accommodation chamber 92 from flowing toward the second tube 77.

As illustrated in FIGS. 4, 6, 9, and 12, the attachment portions 94A and 94B are provided on an upper surface 91T that is a side wall defining the accommodation chamber 92 on the −Z direction side. The attachment portions 94A and 94B are recesses to which the second collection portion 97 is attached. Further, the housing 91 includes, on the upper surface 91T, receiving ports 93A and 93B that open upward in the −Z direction. Further, the position aligning projection 63A is provided on a bottom surface of the housing 91, which is a side wall on the +Z direction side.

The receiving ports 93A and 93B are rectangular through-holes provided on the upper surface 91T. The receiving port 93B is disposed at a position away from the receiving port 93A in the +X direction and the +Y direction. The second collection portion 97 attached to the attachment portion 94A is positioned on the −Y direction side of the receiving port 93A. The second collection portion 97 attached to the attachment portion 94B is positioned on the −Y direction side of the receiving port 93B.

The receiving port 93A is provided at a position facing the nozzle 18 of the discharge portion 14A. When the receiving port 93A faces the nozzle 18 of the discharge portion 14A, the receiving port 93B faces the nozzle 18 of the discharge portion 14B. At this time, the second collection portion 97 attached to the attachment portion 94A is positioned on the −Y direction side of the nozzle surface 22A in the discharge portion 14A. At this time, the second collection portion 97 attached to the attachment portion 94B is positioned on the −Y direction side of the nozzle surface 22B in the discharge portion 14B.

As a result, for example, the carriage 19 moves to a position where the nozzle 18 of the discharge portion 14A is above the upper surface 91T of the housing 91 and faces the receiving port 93A. Then, by performing flushing, pressurization cleaning, or the like, the liquid ejected from the nozzles 18 of the discharge portions 14A and 14B is received in the accommodation chamber 92 via the receiving ports 93A and 93B.

Then, the carriage 19 moves in the −Y direction. As a result, the upper end of the second collection portion 97 attached to the attachment portions 94A and 94B comes into contact with the nozzle surfaces 22A and 22B of the discharge portions 14A and 14B or the liquid adhering to the nozzle surfaces 22A and 22B. In this state, when the carriage 19 moves in the −Y direction, the nozzle surfaces 22A and 22B are wiped. As a result, the liquid adhering to the nozzle surfaces 22A and 22B is collected in the second collection portion 97.

The first collection portion 96 absorbs the liquid collected as waste liquid in the accommodation chamber 92. The first collection portion 96 is made of an absorbent material capable of absorbing the liquid. The first collection portion 96 is configured by, for example, a plurality of plate-shaped absorbent materials accommodated in the accommodation chamber 92. The plate-shaped absorbent material may be, for example, a nonwoven fabric of a polyolefin-based resin or a sponge, or may be a material formed by forming paper such as waste paper into a plate shape. The upper surface, which is the surface on the −Z direction side of the first collection portion 96 accommodated in the accommodation chamber 92, is exposed by the receiving ports 93A and 93B.

The second collection portion 97 is attached to the attachment portions 94A and 94B to be able to collect the liquid adhering to the nozzle surface 22 of the discharge portion 14. The second collection portion 97 is made of an absorbent material capable of absorbing the liquid. The second collection portion 97 of the present embodiment is formed by winding a band-shaped absorbent material around a plate-shaped core material. For example, a nonwoven fabric of a polyolefin-based resin can be adopted as the band-shaped absorbent material.

The plate-shaped core material may be an elastic member such as an elastomer resin or rubber, or may be an absorbent material such as a nonwoven fabric of a polyolefin-based resin or a sponge. When the plate-shaped core material is made of an absorbent material, it is desirable that the density of the absorbent material constituting the plate-shaped core material is higher than the density of the band-shaped absorbent material wound around the plate-shaped core material.

Further, the second collection portion 97 is provided in the housing 91 in a state of not being in contact with the first collection portion 96 due to the side walls configuring the attachment portions 94A and 94B, but may be provided in the housing 91 in a state of being in contact with the first collection portion 96. In this case, by removing a part of the side wall configuring the attachment portions 94A and 94B, the first collection portion 96 and the second collection portion 97 accommodated in the accommodation chamber 92 may be brought into contact with each other.

For example, among the side walls of the attachment portions 94A and 94B, a through-hole is provided in a bottom wall that is a side wall on the +Z direction side. Then, the second collection portion 97 extending in the accommodation chamber 92 is brought into contact with the first collection portion 96 through the through-hole. As a result, since the liquid absorbed by the second collection portion 97 can be moved to the first collection portion 96, the liquid absorbing power of the second collection portion 97 can be maintained. Furthermore, among the plurality of absorbent materials constituting the first collection portion 96, the density of the absorbent material that comes into contact with at least the band-shaped absorbent material of the second collection portion 97 is desirably higher than the density of the band-shaped absorbent material of the second collection portion 97.

The detected portion 64A is provided at a position on the +Y direction side of the receiving port 93A on the upper surface 91T of the housing 91, and protrudes from the upper surface 91T of the housing 91 in the −Z direction. The position of the upper surface, which is the surface on the −Z direction side of the detected portion 64A, is set to the same position as the upper surface of the detected portion 64B in the Z-axis direction. In the Y-axis direction, the cap 71, the pump 81, the holder 84, the receiving ports 93A and 93B, and the second collection portion 97 are positioned between the detected portion 64A and the detected portion 64B. In addition, the detected portion 64A is disposed at the same position as the detected portion 64B in the X-axis direction.

The control portion 16 collectively controls, for example, the liquid discharge apparatus 11. The control portion 16 controls, for example, the discharge portion 14, the carriage movement mechanism 19M, the wiping unit 17, the drive portion 45, and the notification portion 23. The control portion 16 is configured as a circuit including one or more processors, one or more dedicated hardware circuits such as application-specific integrated circuits that execute at least some of various processing, or a combination thereof.

The processor executes various processing according to the computer program. The processor includes a CPU and a memory such as a RAM and a ROM. The memory stores program codes or instructions configured to cause the CPU to execute processing. A memory, that is, a computer-readable medium, includes any readable medium accessible by a general purpose or dedicated computer.

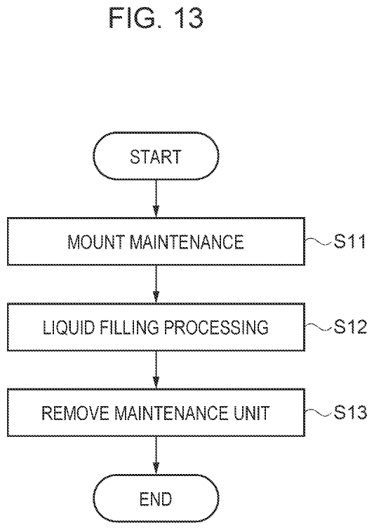

Next, with reference to the flowchart illustrated in FIG. 13, the control executed by the control portion 16 in each step will be described in order when the maintenance unit MA performs liquid filling processing with respect to the discharge portion 14. In the present embodiment, the flow of processing executed by the control portion 16 when performing the liquid filling processing with respect to the discharge portion 14 corresponds to the control method of the liquid discharge apparatus 11.

In step S11, the control portion 16 executes the mounting of the maintenance unit MA. First, the control portion 16 controls the support portion movement mechanism 13M to move the support portion 13 to the placement position Ps (refer to FIGS. 2 and 7). Next, the control portion 16 performs a notification such that the maintenance unit MA is mounted on the mounting portion SP. Specifically, the control portion 16 controls the notification portion 23 to display a message for prompting the operator to mount the maintenance unit MA on the mounting portion SP, on the monitor of the notification portion 23.

When the operator confirms that the maintenance unit MA is mounted on the mounting portion SP by the input of the operator using the touch panel or the like of the notification portion 23, the control portion 16 moves the support portion 13 to the printing position Pr (refer to FIG. 8). Then, from the detection results of the detected portions 64, 65, and 66 by the medium detection sensor 19S or the like, the control portion 16 confirms whether or not the maintenance unit MA is correctly mounted on the support portion 13.

When the maintenance unit MA is not mounted correctly on the support portion 13, the control portion 16 displays a message indicating that the maintenance unit MA is not correctly mounted on the monitor of the notification portion 23. When it is confirmed that the maintenance unit MA is correctly mounted on the support portion 13, the control portion 16 ends the processing in step S11. When the processing of the step S11 is finished, the control portion 16 shifts the processing to step S12.

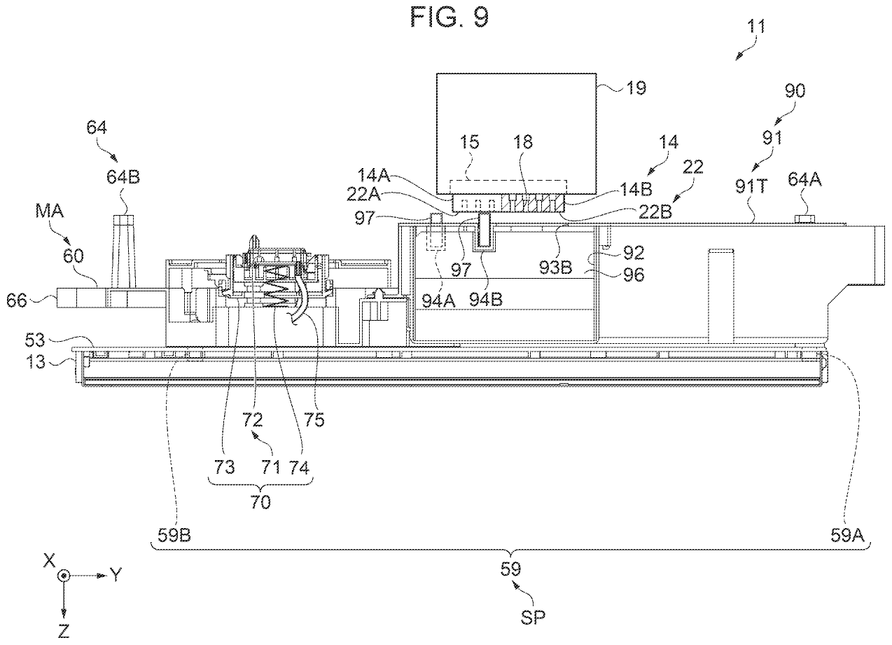

In step S12, the control portion 16 executes a liquid filling processing. First, the control portion 16 controls the carriage movement mechanism 19M, and thus, as illustrated in FIG. 9, the control portion 16 moves the carriage 19 to a position where the nozzles 18 of the discharge portions 14A and 14B face the receiving ports 93A and 93B of the receiving portion 90. Then, the control portion 16 fills the supply flow path and the discharge portions 14A and 14B with the liquid from the liquid accommodation portion 21 by performing pressurization cleaning, flushing, and the like. At this time, the liquid ejected from the nozzles 18 of the discharge portions 14A and 14B is collected in the first collection portion 96 in the accommodation chamber 92 via the receiving ports 93A and 93B.

Next, the control portion 16 controls the carriage movement mechanism 19M to move the carriage 19 in the −Y direction. As a result, the second collection portion 97 wipes the nozzle surfaces 22A and 22B of the discharge portions 14A and 14B. By wiping the nozzle surfaces 22A and 22B, the liquids adhering to the nozzle surfaces 22A and 22B of the discharge portions 14A and 14B are collected in the second collection portion 97.

Next, the control portion 16 controls the carriage movement mechanism 19M to move the carriage 19 to a position where the nozzle 18 of the discharge portion 14B faces the cap 71 of the cap portion 70, for example. In addition, the control portion 16 controls the support portion movement mechanism 13M to move the support portion 13 in the −Z direction, and causes the cap 71 to come into contact with the nozzle surface 22B of the discharge portion 14B as illustrated in FIG. 10. As a result, the space SC where the nozzle 18 of the discharge portion 14B is open is formed.

Then, in a state where the space SC is formed, the control portion 16 performs a notification for prompting the depressurization of the space SC by the pump 81 of the pump portion 80. Specifically, the control portion 16 controls the notification portion 23 to display a message for prompting the operator to move the operation portion 87 of the pump portion 80 in the +Y direction, on the monitor of the notification portion 23. Further, the control portion 16 may display a message for prompting the operator to restrict the slider 89 of the operation portion 87 by the guide slit 86, on the monitor of the notification portion 23.

According to the notification by the notification portion 23, when an operator grips the grip portion 88 and moves the grip portion 88 in the +Y direction, the pusher 83 of the pump 81 slides in the +Y direction. As a result, the space SC is depressurized, and the liquid in the supply flow path and the discharge portion 14A is ejected from the nozzle 18 to the space SC. Then, as indicated by the black arrows in FIG. 12, the liquid and air in the space SC flow toward the pump 81 via the cap 71, the first tube 75, and the one-way valve 76, and are stored in the pump chamber PC.

After a predetermined time elapses from the notification by the notification portion 23 described above, the control portion 16 controls the notification portion 23 to display a message for prompting the operator to move the operation portion 87 of the pump portion 80 in the −Y direction, on the monitor of the notification portion 23. According to the notification by the notification portion 23, the operator moves the grip portion 88 in the −Y direction, and accordingly, the pusher 83 of the pump 81 slides in the −Y direction.

As a result, as indicated by white arrows in FIG. 12, the liquid and air stored in the pump chamber PC flow toward the receiving portion 90 via the first tube 75, the second tube 77, and the one-way valve 78, and are collected in the accommodation chamber 92. The liquid flowing into the accommodation chamber 92 is absorbed by the first collection portion 96.

Next, the control portion 16 controls the support portion movement mechanism 13M and the carriage movement mechanism 19M to bring the cap 71 into contact with the nozzle surface 22A of the discharge portion 14A. As a result, the space SC in which the nozzle 18 of the discharge portion 14A is open is formed.

Then, in a state where the space SC is formed, the control portion 16 performs a notification for prompting the depressurization of the space SC by the pump 81 of the pump portion 80. As a result, in the same manner as the ejection of the liquid from the discharge portion 14B described above, the depressurization by the pump 81 of the space SC where the nozzle 18 of the discharge portion 14A is open and the storage of the liquid and air in the space SC in the pump chamber PC are performed.

Then, the control portion 16 displays a notification for prompting the operator to move the operation portion 87 in the −Y direction, on the monitor of the notification portion 23. As a result, the liquid and air in the pump chamber PC are collected in the accommodation chamber 92. The liquid flowing into the accommodation chamber 92 is absorbed by the first collection portion 96.

Next, the control portion 16 controls the support portion movement mechanism 13M to move the support portion 13 in the +Z direction and separates the cap 71 from the nozzle surface 22A of the discharge portion 14A. The control portion 16 aligns the positions of the nozzle surfaces 22A and 22B and the receiving ports 93A and 93B in the X-axis direction by moving the carriage 19 in the −X direction. In addition, the control portion 16 moves the carriage 19 in the +Y direction. As a result, the second collection portion 97 wipes the nozzle surfaces 22A and 22B of the discharge portions 14A and 14B. By wiping the nozzle surfaces 22A and 22B, the liquids adhering to the nozzle surfaces 22A and 22B of the discharge portions 14A and 14B are collected in the second collection portion 97.

Next, the control portion 16 moves the carriage 19 to a position where the nozzles 18 of the discharge portions 14A and 14B face the receiving ports 93A and 93B of the receiving portion 90. Then, the control portion 16 performs flushing by controlling the discharge portion 14. The liquid discharged from the nozzles 18 of the discharge portions 14A and 14B toward the receiving ports 93A and 93B by flushing is collected in the first collection portion 96 in the accommodation chamber 92 via the receiving ports 93A and 93B.

By executing the liquid filling processing with respect to the discharge portion 14 and the supply flow path including the depressurization of the space SC by the pump 81, air retention in the supply flow path and the discharge portion 14 is reduced in comparison with the liquid filling processing not including the depressurization of the space SC. When the processing of the step S12 is finished, the control portion 16 shifts the processing to step S13.

In step S13, the control portion 16 removes the maintenance unit MA. As illustrated in FIG. 7, the control portion 16 controls the support portion movement mechanism 13M to move the support portion 13 to the placement position Ps. Next, the control portion 16 performs a notification to remove the maintenance unit MA from the mounting portion SP. Specifically, the control portion 16 controls the notification portion 23 to display a message for prompting the operator to remove the maintenance unit MA from the mounting portion SP, on the monitor of the notification portion 23.

When the operator confirms that the maintenance unit MA is removed from the mounting portion SP by the input of the operator using the touch panel or the like of the notification portion 23, the control portion 16 moves the support portion 13 to the printing position Pr. When the processing of the step S13 is finished, the control portion 16 ends the processing.

As described above, according to the maintenance unit MA, the liquid discharge apparatus 11, and the control method of the liquid discharge apparatus 11 according to Embodiment 1, the following effects can be obtained.

The maintenance unit MA is provided to be mounted to the liquid discharge apparatus 11 including the discharge portion 14 that performs printing by discharging the liquid from the nozzle 18 to the medium M when the printing is not performed. The maintenance unit MA includes the cap 71 that can form the space SC in which the nozzle 18 is open, and the pump 81 that can depressurize the space SC.

According to this, since the maintenance unit MA can be mounted only when necessary and can be removed at other times, it is possible to suppress the increase in size of the liquid discharge apparatus 11.

The maintenance unit MA further includes the receiving portion 90 configured to receive, via the space SC, the liquid as waste liquid ejected from the nozzle 18 by the depressurization of the space SC by the pump 81. Accordingly, since the maintenance unit MA can accommodate the liquid as waste liquid in the receiving portion 90, it is possible to suppress the leakage of the waste liquid during the waste liquid treatment.

The maintenance unit MA includes the operation portion 87 capable of manually driving the pump 81. According to this, a driving source such as a motor for driving the pump 81 is not required, and thus, the maintenance unit MA can be used only by mounting.

The pump 81 is a syringe pump. With this configuration, the maintenance unit MA can be configured with a simple configuration.

The liquid discharge apparatus 11 includes the discharge portion 14 and the mounting portion SP on which the maintenance unit MA is detachably mounted. According to this, since the maintenance unit MA can be mounted on the mounting portion SP only when necessary and can be removed at other times, it is possible to suppress the increase in size of the liquid discharge apparatus 11.

The liquid discharge apparatus 11 further includes the support portion 13 that can support the medium M at a position facing the discharge portion 14, and the mounting portion SP is provided in the support portion 13. Accordingly, since the mounting portion SP is provided in the support portion 13, maintenance of the discharge portion 14 is easy.

The liquid discharge apparatus 11 includes the discharge portion 14 that performs printing by discharging the liquid from the nozzle 18 with respect to the medium M. Further, the liquid discharge apparatus 11 includes the maintenance unit MA including the cap 71 that can form the space SC in which the nozzle 18 is open, and the pump 81 that can depressurize the space SC. Further, the liquid discharge apparatus 11 includes the mounting portion SP in which the maintenance unit MA can be mounted when the printing is not performed. In addition, the control method of the liquid discharge apparatus 11 includes performing a notification such that the maintenance unit MA is mounted on the mounting portion SP. Further, the control method of the liquid discharge apparatus 11 includes performing a notification for prompting the depressurization by the pump 81. In addition, the control method of the liquid discharge apparatus 11 includes performing a notification such that the maintenance unit MA is removed from the mounting portion SP.

According to this, since the maintenance unit MA can be mounted when necessary and the space SC can be depressurized by the pump 81, the increase in size of the liquid discharge apparatus 11 can be suppressed.

### 2. Embodiment 2

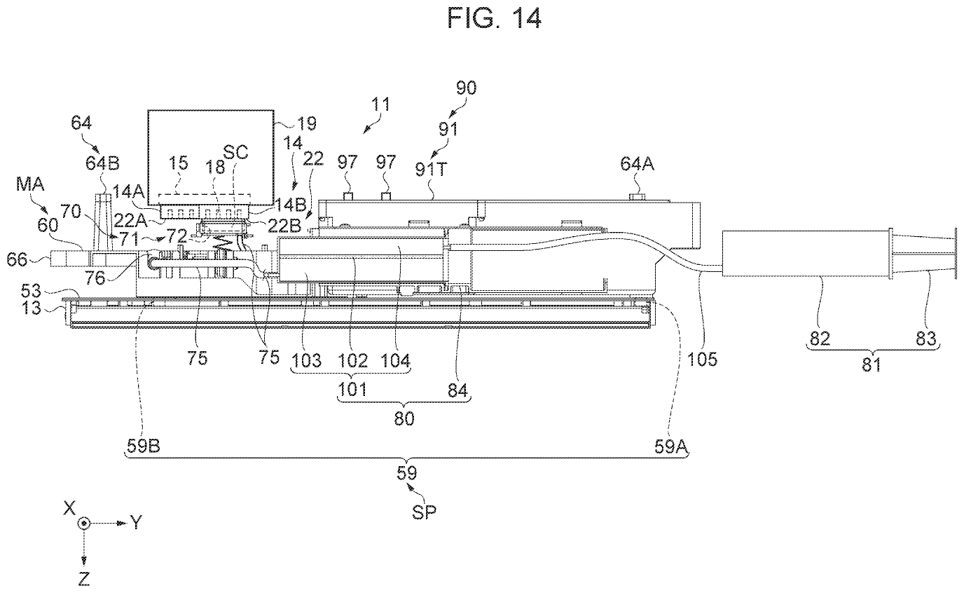

As illustrated in FIG. 14, the maintenance unit MA of the liquid discharge apparatus 11 according to Embodiment 2 includes an intermediate chamber 101 between the cap 71 of the cap portion 70 and the pump 81 of the pump portion 80. The intermediate chamber 101 includes a liquid chamber 103 coupled to the cap 71 by the first tube 75, a gas chamber 104, and a partition wall 102 partitioning the liquid chamber 103 and the gas chamber 104. The partition wall 102 is constituted by a gas-liquid separation membrane that allows the passage of gas and restricts the passage of liquid.

In the present embodiment, the holder 84 of the pump portion 80 holds the intermediate chamber 101. The pump 81 of the present embodiment is coupled to the gas chamber 104 of the intermediate chamber 101 by a third tube 105. Therefore, the pump 81 of the present embodiment can be manually driven on the outside of the housing 12 in a state where the support portion 13 on which the maintenance unit MA is mounted is positioned at the printing position Pr. Furthermore, the configuration of the pump 81 according to the present embodiment is the same as that of the pump 81 (refer to FIGS. 11 and 12) according to Embodiment 1. The liquid discharge apparatus 11 of the present embodiment is the same as the liquid discharge apparatus 11 of Embodiment 1 except for the above-described configuration.

Also in the present embodiment, in a state where the space SC is formed, by sliding the pusher 83 of the pump 81 in the direction in which the volume of the pump chamber PC formed between the outer pipe 82 and the pusher 83 increases, the space SC is depressurized. As a result, the liquid in the supply flow path and the discharge portion 14 is ejected from the nozzle 18 to the space SC. Then, the liquid and air in the space SC flow toward the intermediate chamber 101 via the cap 71, the first tube 75, and the one-way valve 76, and are stored in the liquid chamber 103.

By sliding the pusher 83 of the pump 81 in the direction in which the volume of the pump chamber PC decreases, the liquid and air stored in the liquid chamber 103 flow toward the receiving portion 90 via the first tube 75, the second tube 77, and the one-way valve 78. Furthermore, in the present embodiment, the liquid does not flow into the gas chamber 104, the third tube 105, and the pump chamber PC of the pump 81. Therefore, for example, when the pusher 83 falls out from the outer pipe 82 of the pump 81, the concern that the liquid leaks from the pump chamber PC can be reduced.

### 3. Embodiment 3

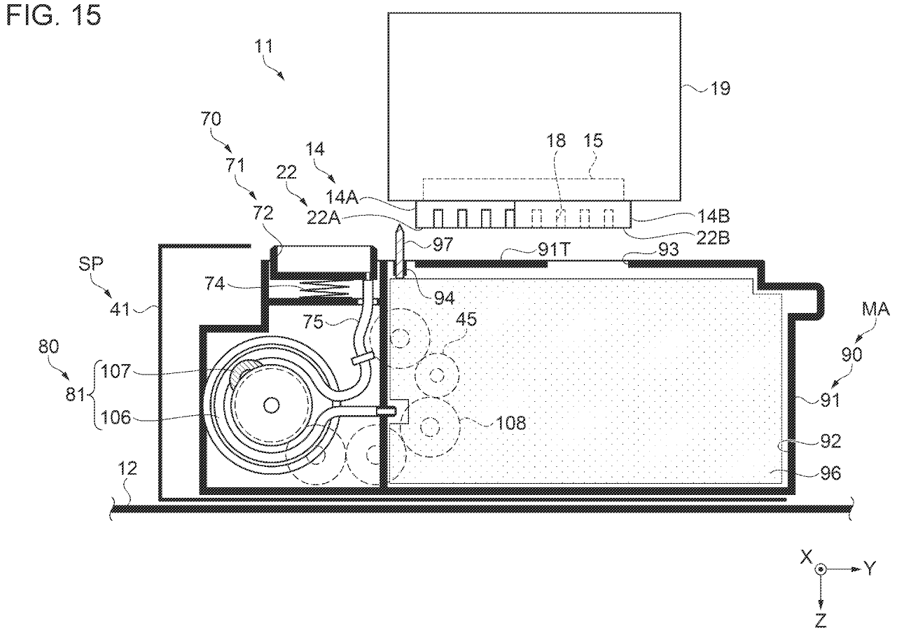

The mounting portion SP included in the liquid discharge apparatus 11 according to Embodiment 3 is the holding portion 41 from which the wiping unit 17 is removed. Therefore, as illustrated in FIG. 15, the housing 91 of the receiving portion 90 in the maintenance unit MA of the present embodiment is in an aspect of being attachable to and detachable from the holding portion 41. In addition, the cap portion 70 and the pump portion 80 in the maintenance unit MA are provided in the housing 91 of the receiving portion 90. Therefore, in the present embodiment, the maintenance unit MA does not include the base portion 60.

In addition, the pump 81 of the pump portion 80 in the present embodiment is a tube pump in which the roller 107 rotates around the axis center while crushing the pump tube 106. Further, the maintenance unit MA includes a driving force transmission mechanism 108 that is coupled to the drive portion 45 to transmit the driving force of the drive portion 45 to the pump 81. As a result, in a state where the maintenance unit MA is mounted on the holding portion 41, the control portion 16 controls the drive portion 45, and accordingly, the pump 81 can be driven. The liquid discharge apparatus 11 of the present embodiment is the same as the liquid discharge apparatus 11 of Embodiment 1 except for the above-described configuration.

Then, for example, in the liquid filling processing with respect to the discharge portion 14 by the maintenance unit MA, the control portion 16 drives the pump 81 by the drive portion 45 in a state where the space SC is formed, and accordingly, the depressurization of the space SC is executed. As a result, the liquid in the supply flow path and the discharge portion 14 is ejected from the nozzle 18 to the space SC. Then, the liquid and air in the space SC flow toward the accommodation chamber 92 via the cap 71, the first tube 75, and the pump tube 106, and are collected in the accommodation chamber 92. Then, the liquid flowing into the accommodation chamber 92 is absorbed by the first collection portion 96.

Further, in the present embodiment, the maintenance unit MA may include a cap raising and lowering mechanism capable of moving the cap 71 in the Z-axis direction. Then, the driving force transmission mechanism 108 can transmit the driving force of the drive portion 45 to the pump 81 and the cap raising and lowering mechanism. In this case, the control portion 16 may control the drive portion 45 and the driving force transmission mechanism 108 to bring the cap 71 into contact with the nozzle surface 22 of the discharge portion 14 and form the space SC.

As described above, according to the maintenance unit MA and the liquid discharge apparatus 11 according to Embodiment 3, the following effects can be obtained.

The pump 81 included in the maintenance unit MA is a tube pump. With this configuration, the maintenance unit MA can be configured with a simple configuration.

The liquid discharge apparatus 11 includes the discharge portion 14 and the mounting portion SP on which the maintenance unit MA, in which the pump 81 is a tube pump, is detachably mounted. According to this, since the maintenance unit MA can be mounted on the mounting portion SP only when necessary and can be removed at other times, it is possible to suppress the increase in size of the liquid discharge apparatus 11.

The liquid discharge apparatus 11 includes the holding portion 41 that holds the wiping unit 17 configured to wipe the discharge portion 14 to be attachable and detachable, and the mounting portion SP is the holding portion 41 from which the wiping unit 17 is removed. According to this, since the mounting portion SP is provided in the holding portion 41 in which the wiping unit 17 is held, maintenance of the discharge portion 14 is easy.

The holding portion 41 includes the drive portion 45, and the wiping unit 17 includes the band-shaped absorbing member 25 capable of absorbing the liquid, the rotating body 26 for feeding the absorbing member 25, and the rotating body 27 for winding the absorbing member 25. When the wiping unit 17 is mounted on the holding portion 41, the drive portion 45 drives at least the rotating body 27, and when the maintenance unit MA is mounted on the holding portion 41, the drive portion 45 drives the pump 81. As a result, the drive portion 45 used to drive the wiping unit 17 can be used to drive the pump 81 of the maintenance unit MA.

The maintenance unit MA according to the above embodiment of the present disclosure basically has the configurations as described above. However, as a matter of course, the configurations may be partially changed or omitted within the scope not departing from the concept of the present disclosure. In addition, the liquid discharge apparatus 11 according to the above embodiment of the present disclosure basically has the configurations as described above. However, as a matter of course, the configurations may be partially changed or omitted within the scope not departing from the concept of the present disclosure.

In addition, the control method of the liquid discharge apparatus 11 according to the above embodiment of the present disclosure basically has the configurations as described above. However, as a matter of course, the configurations may be partially changed or omitted within the scope not departing from the concept of the present disclosure. Further, the above embodiment and other embodiments described below can be implemented in combination with each other within a technically consistent range. Hereinafter, other embodiments will be described.

In the above embodiment, the control portion 16 may perform filling of the supply flow path and the discharge portion 14 with the liquid in step S12 of the flowchart illustrated in FIG. 13 by suction cleaning. In this case, the suction cleaning is performed using the cap portion 70 and the pump portion 80 of the maintenance unit MA.

In the above embodiment, the cap portion 70 may have a cap 71A (not illustrated) that can come into contact with the nozzle surface 22A of the discharge portion 14A, and a cap 71B (not illustrated) that can come into contact with the nozzle surface 22B of the discharge portion 14B. A space SCA (not illustrated) in which the nozzle 18 of the discharge portion 14A opens and the space SCB (not illustrated) in which the nozzle 18 of the discharge portion 14B opens may be simultaneously formed by the caps 71A and 71B. Thereby, by driving the pump 81, the spaces SCA and SCB can be simultaneously depressurized.

In the above embodiment, the second collection portion 97 may not be made of an absorbent material capable of absorbing the liquid. For example, as illustrated in FIG. 15, the second collection portion 97 may be made of a strip-shaped rubber member, an elastomer resin, or the like.

The pump portion 80 in Embodiment 1 described above may not include the operation portion 87, similarly to the pump portion 80 in Embodiment 2 described above. In this case, the pump portion 80 in Embodiment 1 and Embodiment 2 may include a drive mechanism and a drive motor for driving the pusher 83 of the pump 81.

In Embodiment 1 described above and Embodiment 2 described above, the pump 81 of the pump portion 80 may not be a syringe pump. For example, the pump 81 may be a tube pump, as in Embodiment 3. In this case, the tube pump may be provided with a handle that rotates the roller 107 of the tube pump about the axis. As a result, the tube pump can be manually driven. In this case, the handle provided on the tube pump is an example of an operation portion capable of manually driving the pump 81.

In Embodiment 3 described above, the maintenance unit MA may not include the driving force transmission mechanism 108. In this case, the tube pump may be provided with a handle that rotates the roller 107 of the tube pump about the axis. As a result, the tube pump can be manually driven. In this case, the handle provided on the tube pump is an example of an operation portion capable of manually driving the pump 81.

In Embodiment 3 described above, the pump 81 of the pump portion 80 may not be a tube pump. For example, the pump 81 may be a syringe pump, as in Embodiment 1 and Embodiment 2. Further, in this case, the maintenance unit MA may include the operation portion 87 that manually drives the pump 81. Alternatively, the maintenance unit MA may slide the pusher 83 of the pump 81 by transmitting the driving force of the drive portion 45 by the driving force transmission mechanism 108. According to these, in the liquid discharge apparatus 11, since the mounting portion SP is provided in the holding portion 41 in which the wiping unit 17 is held, the maintenance of the discharge portion 14 is easy.

In Embodiment 2 described above, the intermediate chamber 101 of the pump portion 80 may not include the gas chamber 104. In this case, the intermediate chamber 101 may not include the partition wall 102.

In the above embodiment, an on-off valve configured to allow opening and closing of the supply flow path may be provided in the supply flow path that couples the liquid accommodation portion 21 and the discharge portion 14. Then, for example, when suction cleaning is performed by the maintenance unit MA, the control portion 16 closes the on-off valve before the space SC is depressurized by the pump 81. Then, in the state where the space SC is depressurized, the control portion 16 opens the on-off valve. According to this, it is possible to apply a large negative pressure to the supply flow path on the discharge portion 14 side of the on-off valve and the discharge portion 14 as compared with the case where the on-off valve is not provided. Therefore, in the suction cleaning by the maintenance unit MA, air bubbles, foreign matter, and the like in the supply flow path and the discharge portion 14 are easily ejected from the nozzle 18 of the discharge portion 14. Furthermore, when the on-off valve is manually opened and closed, the control portion 16 displays a notification for prompting the operator to open and close the on-off valve on the monitor of the notification portion 23, and thus the opening and closing of the on-off valve is performed.

In Embodiment 1 described above, the mounting portion SP may not be provided in the support portion 13. For example, the mounting portion SP may be provided at a position between the side wall of the housing 12 on the +X direction side and the support portion 13.

In the above embodiment, the control portion 16 may be coupled to the external apparatus through a communication interface (not illustrated), a communication cable, a wireless communication line, or the like provided in the liquid discharge apparatus 11. Then, the control portion 16 may notify the state of the liquid discharge apparatus 11, a request to the operator to operate the liquid discharge apparatus 11, and the like by the external apparatus. For example, in the liquid filling processing with respect to the discharge portion 14, the control portion 16 may display, on the display portion of the external apparatus, a message for prompting the attachment and detachment of the maintenance unit MA to and from the mounting portion SP, the drive operation of the pump 81, and the like to notify the operator.

In the above embodiment, at least a part of the receiving portion 90 of the maintenance unit MA may be positioned outside the housing 12 when the maintenance unit MA is mounted on the mounting portion SP and used. For example, as illustrated in FIG. 15, in the receiving portion 90, an end of the receiving portion 90 on the +Y direction side, which is the front side in the mounting direction of the maintenance unit MA, may protrude outward from the holding portion 41, which is the mounting portion SP. According to this, by increasing the accommodation chamber 92 of the receiving portion 90, the amount of the liquid that can be received in the accommodation chamber 92 can be increased.

In the above embodiment, the receiving portion 90 of the maintenance unit MA may be provided to be replaceable with respect to the maintenance unit MA.

In the above embodiment, the maintenance unit MA may be capable of executing the maintenance processing of the discharge portion 14 only once or may be capable of executing the maintenance processing a plurality of times. Further, when the maintenance processing of the discharge portion 14 can be executed a plurality of times, the maintenance unit MA may include, for example, a storage element capable of storing the amount of liquid that can be received by the receiving portion 90. In this case, the liquid discharge apparatus 11 may include a reading portion capable of reading the content stored in the storage element. Then, the control portion 16 may determine whether or not it is possible to execute the maintenance processing of the discharge portion 14 by the maintenance unit MA, based on the storage content of the storage element read by the reading portion. Then, when the execution of the maintenance processing of the discharge portion 14 by the maintenance unit MA is not possible, it may be notified that the execution of the maintenance processing of the discharge portion 14 by the maintenance unit MA mounted on the mounting portion SP is not possible.

In the above embodiment, printing may be performed with respect to the maintenance unit MA that cannot be used for the maintenance processing of the discharge portion 14 indicating that the maintenance unit MA cannot be used. For example, when the maintenance unit MA cannot receive a liquid in the receiving portion 90 anymore, the liquid discharge apparatus 11 may print “full” or the like on the upper surface 91T of the housing 91 by the discharge portion 14. In addition, in this case, the ink used for the printing is desirably ink having a color in which the printing is easy to be visually recognized among the ink discharged by the discharge portion 14, and white or yellow ink is desirable when the upper surface 91T is black.

In the above embodiment, when the liquid discharged by the discharge portion 14 is UV ink, the ultraviolet rays may be emitted from the processing portion 15 toward the maintenance unit MA that cannot be used for the maintenance processing of the discharge portion 14. In this case, in the maintenance unit MA, the ultraviolet rays may be emitted from the processing portion 15 toward the receiving port 93, the second collection portion 97, the cap 71, and the like. Accordingly, it is possible to suppress the adhesion and leakage of the liquid to the outside by the maintenance unit MA removed from the mounting portion SP.

In other embodiments other than Embodiment 3, the maintenance unit MA may not be attached to and detached from the mounting portion SP at the placement position Ps of the support portion 13. For example, the maintenance unit MA may be attached to and detached from the mounting portion SP at the printing position Pr of the support portion 13. In this case, the liquid discharge apparatus 11 may include an opening/closing cover capable of opening and closing the upper part of the support portion 13 at a position above the support portion 13 positioned at the printing position Pr in the housing 12. As a result, by opening the opening/closing cover of the housing 12, the maintenance unit MA can be attached to and detached from the support portion 13 positioned at the printing position Pr.

In the other embodiments other than Embodiment 3 described above, the receiving portion 90 of the maintenance unit MA may not include the receiving port 93 and the second collection portion 97. In this case, the collection of the liquid as the waste liquid generated by wiping, flushing, and pressurization cleaning of the discharge portion 14 executed in the maintenance of the discharge portion 14 is performed by the wiping unit 17. Further, in this case, the receiving portion 90 may not be attached to the base portion 60. When the maintenance unit MA is mounted on the mounting portion SP and used, the receiving portion 90 may be positioned outside the housing 12 in a state where the second tube 77 is coupled.

In other embodiments other than Embodiment 3 described above, the maintenance unit MA may not include the receiving portion 90. In this case, the collection of the liquid as the waste liquid generated by wiping, flushing, and pressurization cleaning of the discharge portion 14 executed in the maintenance of the discharge portion 14 is performed by the wiping unit 17. In this case, by the depressurization of the space SC, the liquid and air in the supply flow path and the discharge portion 14 ejected to the space SC are collected in the pump chamber PC in the case of Embodiment 1, and are collected in the liquid chamber 103 in the case of Embodiment 2. In addition, the liquid collected in the pump chamber PC of Embodiment 1 or the liquid collected in the liquid chamber 103 of Embodiment 2 is discarded after the maintenance unit MA is removed from the mounting portion SP.

What is claimed is:

1. A maintenance unit configured to be mounted on a liquid discharge apparatus including a discharge portion that performs printing by discharging a liquid from a nozzle to a medium when the printing is not performed, the maintenance unit comprising:
a space forming portion configured to form a space in which the nozzle is open; and
a depressurizing portion configured to depressurize the space.

2. The maintenance unit according to claim 1, further comprising:
a receiving portion configured to receive, via the space, the liquid as waste liquid ejected from the nozzle by depressurizing the space by the depressurizing portion.

3. The maintenance unit according to claim 1, further comprising:
an operation portion configured to manually drive the depressurizing portion.

4. The maintenance unit according to claim 1, wherein
the depressurizing portion is a syringe pump.

5. The maintenance unit according to claim 1, wherein
the depressurizing portion is a tube pump.

6. A liquid discharge apparatus comprising:
the discharge portion; and
a mounting portion on which the maintenance unit according to claim 1 is detachably mounted.

7. The liquid discharge apparatus according to claim 6, further comprising:
a support portion configured to support the medium at a position facing the discharge portion, wherein
the mounting portion is provided in the support portion.

8. The liquid discharge apparatus according to claim 6, further comprising:
a holding portion that holds a wiping unit configured to wipe the discharge portion to be attachable and detachable, wherein
the mounting portion is the holding portion from which the wiping unit is removed.

9. A liquid discharge apparatus comprising:
the discharge portion; and
a mounting portion on which the maintenance unit according to claim 5 is detachably mounted.

10. The liquid discharge apparatus according to claim 9, further comprising:
a holding portion that holds a wiping unit configured to wipe the discharge portion to be attachable and detachable, wherein
the mounting portion is the holding portion from which the wiping unit is removed.

11. The liquid discharge apparatus according to claim 10, wherein
the holding portion includes a drive portion,
the wiping unit includes a band-shaped absorbing member configured to absorb the liquid, a feeding shaft for feeding the absorbing member, and a winding shaft winding the absorbing member,
the drive portion drives at least the winding shaft when the wiping unit is mounted on the holding portion, and
the drive portion drives the depressurizing portion when the maintenance unit is mounted on the holding portion.

12. A control method of a liquid discharge apparatus including a discharge portion that performs printing by discharging a liquid from a nozzle with respect to a medium, a maintenance unit having a space forming portion configured to form a space in which the nozzle is open, and a depressurizing portion configured to depressurize the space, and a mounting portion configured to mount the maintenance unit when the printing is not performed, the method comprising:
performing a notification to mount the maintenance unit on the mounting portion;
performing a notification for prompting depressurization by the depressurizing portion; and
performing a notification to remove the maintenance unit from the mounting portion.
